(19) United States
(12) Patent Application Publication
(10) Pub. No.: US 2022/0140483 A1
(43) Pub. Date: May 5, 2022

(54) Antenna Structure

(71) Applicant: DYLAN-TEK CO., LTD., Taipei City (TW)

(72) Inventor: Kuo-Lun Hung, Taipei City (TW)

(21) Appl. No.: 17/083,320

(22) Filed: Oct. 29, 2020

(51) Int. Cl. H01Q 9/04; H01Q 1/48; H01Q 5/35

(52) U.S. Cl. CPC H01Q 9/0471; H01Q 5/35; H01Q 1/48

(57) ABSTRACT

An antenna structure is disclosed. The antenna structure includes a first radiator in a shape corresponding to a circle and a plurality of second radiators each in a shape corresponding to an arc. The first radiator has a first feed-in point and a second feed-in point. One of the plurality of second radiators has a third feed-in point, and another of the plurality of second radiators has a fourth feed-in point.

### BACKGROUND OF THE INVENTION

### 1. Field of the Invention

The present invention relates to an antenna structure, and more particularly, to an antenna structure, which is dual-polarized, dual-band, broadband, or polarization controllable.

### 2. Description of the Prior Art

It is always desirable to provide a compact antenna capable of servicing all required frequency bands. However, since a patch antenna is typically efficient only in a narrow frequency band, its applications tend to be restricted in amount. The bandwidth of a patch antenna is normally narrow, which is also a major disadvantage of this type of antenna. Furthermore, possible polarization direction(s) of a patch antenna is predetermined and limited because of its structure. With the advance of wireless communication technology, the demand for transmission capacity and wireless network performance increases. Consequently, there is still room for improvement.

### SUMMARY OF THE INVENTION

Therefore, the present application primarily provides an antenna structure, which is dual-polarized, dual-band, broadband, or polarization controllable.

An embodiment of the present application discloses an antenna structure. The antenna structure comprises a first radiator in a shape corresponding to a circle and a plurality of second radiators each in a shape corresponding to an arc. The first radiator has a first feed-in point and a second feed-in point. One of the plurality of second radiators has a third feed-in point, and another of the plurality of second radiators has a fourth feed-in point.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an antenna according to an embodiment of the present invention.

FIG. 2 is a top-view schematic diagram of radiators of the antenna shown in FIG. 1.

FIG. 3 and FIG. 4 are schematic diagrams of resonance characteristics for the first frequency band and the second frequency band of the antenna shown in FIG. 1, respectively.

FIG. 5 is a top-view schematic diagram of the radiator of an antenna according to an embodiment of the present invention.

FIG. 6 and FIG. 7 are schematic diagrams of resonance characteristics for the first frequency band and the second frequency band of the antenna shown in FIG. 1, respectively.

FIG. 8 is a schematic diagram of an antenna according to an embodiment of the present invention.

FIG. 9 and FIG. 10 are schematic diagrams of radiation field pattern for the first frequency band and the second frequency band of the antenna shown in FIG. 1, respectively.

### DETAILED DESCRIPTION

Please note that the figures are only for illustration and the figures may not be to scale. The scale may be further modified according to different design considerations. In the following description and claims, the terms “include” and “comprise” are used in an open-ended fashion, and thus should be interpreted to mean “include, but not limited to”. Use of ordinal terms such as “first” and “second” does not by itself connote any priority, precedence, or order of one element over another or the chronological sequence in which acts of a method are performed, but are used merely as labels to distinguish one element having a certain name from another element having the same name. Different technical features described in the following embodiments may be mixed or combined in various ways if they are not conflict to each other.

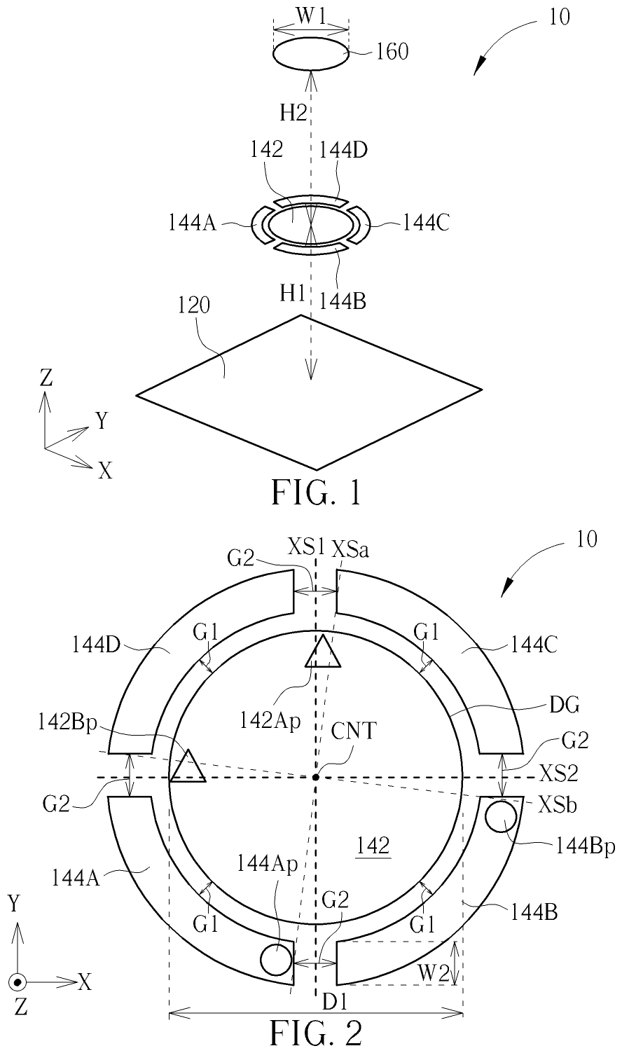

Please refer to FIG. 1 and FIG. 2. FIG. 1 is a schematic diagram of an antenna 10 according to an embodiment of the present invention. FIG. 2 is a top-view schematic diagram of radiators 142, 144A, 144B, 144C, 144D of the antenna 10 shown in FIG. 1. The antenna 10 may include a ground plane 120, the radiators 142-144D, and a director 160. The radiator 142 (also referred to as first radiator) has a shape corresponding to a circle. Each of the radiators 144A-144D (also referred to as second radiator) has a shape corresponding to an arc. The radiators 144A-144D are equally spaced apart from the radiator 142 without being electrically connected to the radiator 142. The radiators 144A-144D are evenly distributed and symmetrically arranged to surround the radiator 142. The radiators 144A-144D are concentric with the radiator 142. The radiator 142 has feed-in points 142Ap and 142Bp; the radiators 144A and 144B have feed-in points 144Ap and 144Bp, respectively. The feed-in points 142Ap-144Bp, which are configured to feed radio-frequency (RF) energy to the antenna 10, are electrically isolated/insulated from the ground plane 120 or the director 160, which is concentric with the radiator 142 as well.

Briefly, with the radiator 142 and the radiators 144A-144D surrounding the radiator 142, the antenna 10 has two frequency bands. With the feed-in points 142Ap and 142Bp (or the feed-in points 144Ap and 144Bp) of the antenna 10, dual polarization capability may be developed. With the symmetry of the structure of the antenna 10, polarizations may be changed without altering the arrangement of the radiators 142 and 144A-144D. With the director 160, the antenna 10 is able to provide broad band operation. The antenna 10 of the present invention is therefore a dual-polarized dual-band broadband antenna.

Specifically, the antenna 10 alone may achieve communication in (at least) two frequency bands within a compact assembly. A first resonant frequency (which may be a central frequency for a first frequency band) occurs when RF energy is fed into the feed-in point 142Ap (or 142Bp) and the radiator 142 is resonated alone. When RF energy is fed into the feed-in point 144Ap (or 144Bp), at least one of the radiators 144A-144D is coupled to the radiator 142 so as to generated a second resonant frequency (which may be a central frequency for a second frequency band) lower than the first resonant frequency. The radiators 144A-144D equivalently enlarge the effective size of the antenna 10, and thus lower the resonant frequency of the antenna 10. The coupling of the radiators 142 and 144A-144D facilitates dual frequency band communication.

In terms of the fifth generation mobile communications (5G), the antenna 10 of the present invention may cover frequency bands in a frequency range of 26.5 gigahertz (GHz) to 29.5 GHz (serving as, for example, the second frequency band) and in a frequency range of 37 GHz to 40 GHz (serving as, for example, the first frequency band). The antenna 10 may meet the band requirements of 5G mmWave Band n257, Band n261 and Band n260, which are frequency bands defined for millimeter-wave communication in 5G New Radio (NR) networks.

Moreover, the antenna 10 alone has dual polarization performance within a compact assembly so as to support Multi-input Multi-output (MIMO) communication technology. A linearly polarized radiation pattern may be generated by exciting the radiator 142 at the feed-in point 142Ap, and another linearly polarized radiation pattern may be generated by exciting the radiator 142 at the feed-in point 142Bp. In some embodiments, the feed-in point 142Ap may be located on an axis XSa (for instance, a symmetric axis of the radiator 142). When the feed-in point 142Ap is fed, the antenna 10 may generate a linearly polarized radiation pattern (for instance, vertical polarization) with the polarization aligned with the axis XSa. In some embodiments, the feed-in point 142Bp may be located on an axis XSb (for instance, another symmetric axis of the radiator 142). When the feed-in point 142Bp is fed, the antenna 10 may generate another linearly polarized radiation pattern (for instance, horizontal polarization) with the polarization aligned with the axis XSb. If the axis XSa is perpendicular to the axis XSb, the two polarization directions may be orthogonal.

Similarly, when the feed-in point 144Ap, which may be located on the axis XSa as well in some embodiments, is fed, the antenna 10 may generate a linearly polarized radiation pattern (for instance, vertical polarization) with the polarization aligned with the axis XSa. When the feed-in point 142Bp, which may be located on the axis XSb as well in some embodiments, is fed, the antenna 10 may generate another linearly polarized radiation pattern (for instance, horizontal polarization) with the polarization aligned with the axis XSb. That is to say, the antenna 10 is able to provide two (orthogonal) polarizations (such as the combination of vertical and horizontal polarizations or the combination of positive (+45 degrees) and negative (−45 degrees) slant polarizations), and hence is capable of achieving a 2×2 MIMO function.

In addition, the antenna 10 allows polarization control. The antenna 10 may be vertically polarized and horizontally polarized, and may be changed into +45 degrees slant polarization and −45 degrees slant polarization as shown in FIG. 4 or even into other polarizations as long as the polarizations are orthogonal to each other to provide two signal channels of extremely low correlations.

In FIG. 1, when the feed-in point 142Ap (also referred to as first feed-in point) is fed, the antenna 10 may radiate with vertical polarization in the first frequency band. When the feed-in point 142Bp (also referred to as second feed-in point) is fed, the antenna 10 may radiate with horizontal polarization in the first frequency band. When the feed-in point 144Ap (also referred to as third feed-in point) is fed, the antenna 10 may radiate with vertical polarization in the second frequency band. When the feed-in point 144Bp (also referred to as fourth feed-in point) is fed, the antenna 10 may radiate with horizontal polarization in the second frequency band.

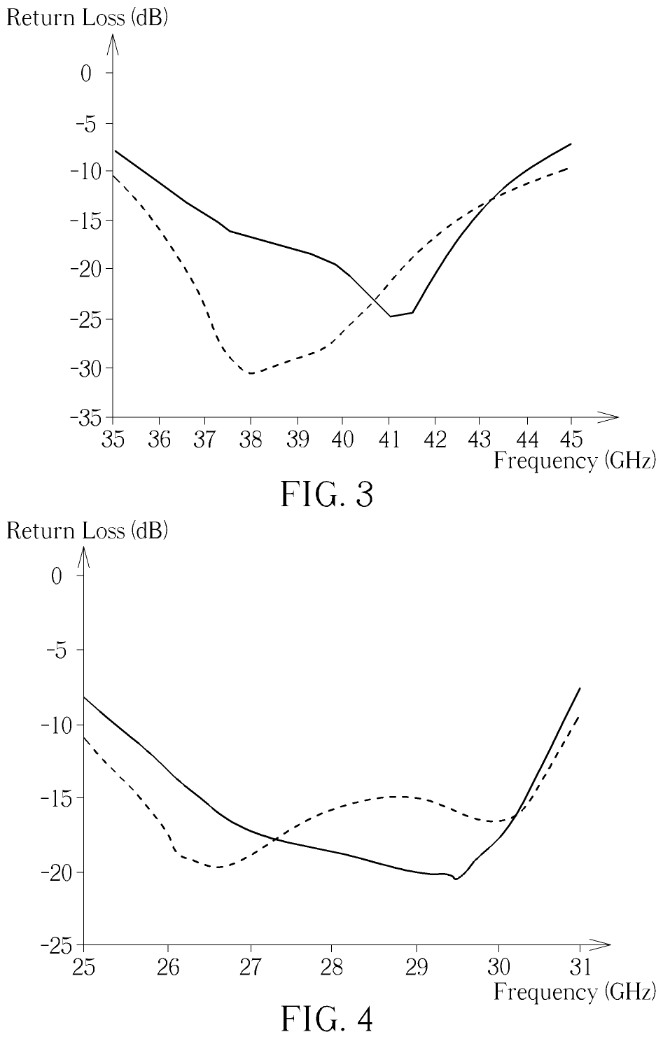

Please refer to FIG. 3 and FIG. 4. FIG. 3 is a schematic diagram of resonance characteristics for the first frequency band of the antenna 10 shown in FIG. 1. FIG. 4 is a schematic diagram of resonance characteristics for the second frequency band of the antenna 10 shown in FIG. 1. In FIG. 3 and FIG. 4, return loss versus frequency of vertical polarization and horizontal polarization are presented by a solid curve and a dash curve respectively. The S-parameter S11 of the antenna 10 is less than −10 dB and meet the band requirements of 5G mmWave Band n257, Band n261 and Band n260.

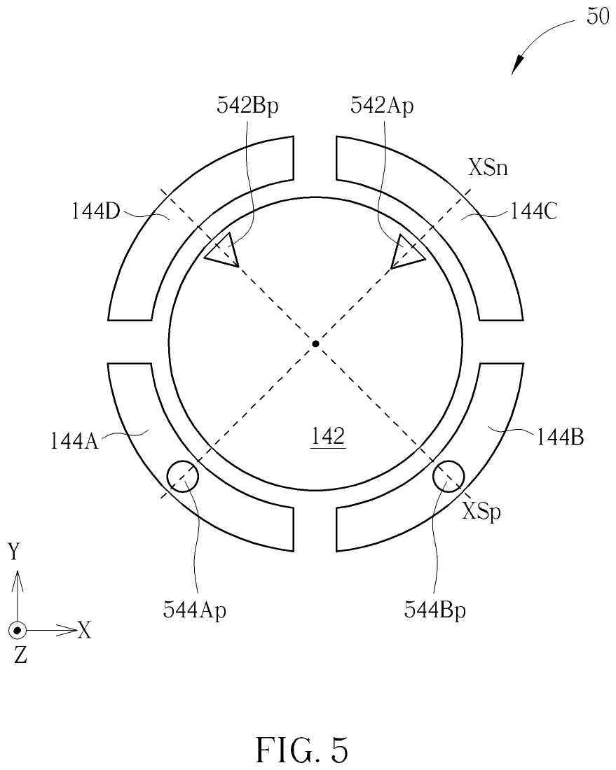

Please refer to FIG. 5, which is a top-view schematic diagram of the radiator 142-144D of an antenna 50 according to an embodiment of the present invention. The structure of the antenna 50 shown in FIG. 5 is similar to that of the antenna 10 shown in FIG. 1, and hence the same numerals and notations denote the same components in the following description. In FIG. 5, the radiator 142 has feed-in points 542Ap and 542Bp, which are located at the top right and the top left of the antenna 50 within the radiator 142, respectively. The radiators 144A and 144B have feed-in points 544Ap and 544Bp, which are located at the bottom left and the bottom right of the antenna 50 within the radiators 144A and 144B, respectively.

When the feed-in point 542Ap (also referred to as first feed-in point), which may be located on an axis XSn (for instance, a symmetric axis of the radiators 142-144D), is fed, the antenna 10 may produce a linearly polarized radiation pattern (for instance, −45 degrees slant polarization) with the polarization aligned with the axis XSn in the first frequency band. When the feed-in point 542Bp (also referred to as second feed-in point), which may be located on an axis XSp (for instance, another symmetric axis of the radiators 142-144D), is fed, the antenna 10 may generate a linearly polarized radiation pattern (for instance, +45 degrees slant polarization) with the polarization aligned with the axis XSp in the first frequency band. When the feed-in point 544Ap (also referred to as third feed-in point), which may be located on the axis XSn as well, is fed, the antenna 10 may produce a linearly polarized radiation pattern (for instance, −45 degrees slant polarization) with the polarization aligned with the axis XSn in the second frequency band. When the feed-in point 544Bp (also referred to as fourth feed-in point), which may be located on the axis XSp as well, is fed, the antenna 10 may generate a linearly polarized radiation pattern (for instance, +45 degrees slant polarization) with the polarization aligned with the axis XSp in the second frequency band.

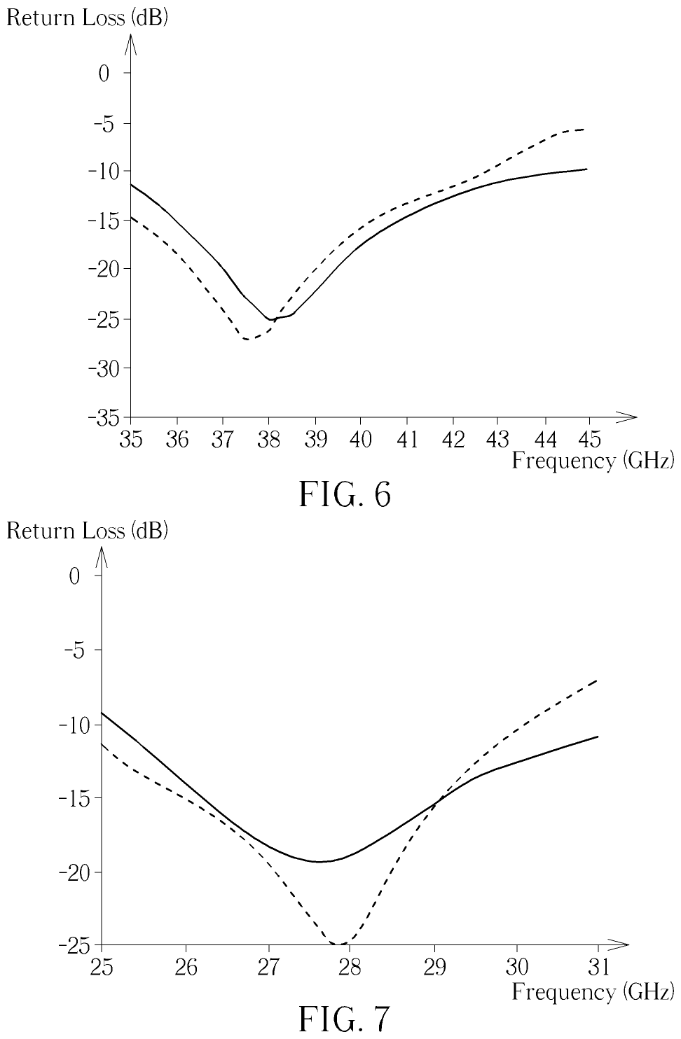

Please refer to FIG. 6 and FIG. 7. FIG. 6 is a schematic diagram of resonance characteristics for the first frequency band of the antenna 50 shown in FIG. 5. FIG. 7 is a schematic diagram of resonance characteristics for the second frequency band of the antenna 50 shown in FIG. 5. In FIG. 6 and FIG. 7, return loss versus frequency of vertical polarization and horizontal polarization are presented by a solid curve and a dash curve respectively. The S-parameter S11 of the antenna 50 is less than −10 dB and meets the band requirements of 5G mmWave Band n257, Band n261 and Band n260.

The structure symmetry may ensure the adjustability of polarizations of the antenna 10 or 40. As shown in FIG. 1 and FIG. 5, the radiators 144A-144D are symmetrically placed around the radiator 142. Because of the symmetry of the structure of the antenna 10 or 40, different polarizations (for instance, vertical polarization or −45 degrees slant polarization) may be achieved by adjusting the location of the feed-in points (for instance, the feed-in point 142Ap or 542Ap) without changing the structure of the antenna 10 or 50 (namely, the arrangement of the radiators 142 and 144A-144D). A feed-in point (for instance, the feed-in point 142Ap or 542Ap) may be located on a first symmetric axis of the radiator 142 or a second symmetric axis of the radiator 142 (or changed from one to another), and an angle between the first symmetric axis and the second symmetric axis is 45 degrees. The antenna 10 or 50 may be switch between a first combination of vertically polarization and horizontally polarization and a second combination of +45 degrees slant polarization and −45 degrees slant polarization. In other words, two orthogonal polarizations may be oriented in an arbitrary way. The two orthogonal polarization directions may be selected/determined/changed according to usage scenario.

Besides, the director 160 may be utilized to increase the bandwidth. Coupling occurs between the director 160 and the radiators 142-144D, such that the frequency coverage of the antenna 10 or 50 increases without affecting its antenna pattern, operation modes, or polarization(s). Boardband design is therefore achieved.

The antenna 10 shown in FIG. 1 and the antenna 50 shown in FIG. 5 are exemplary embodiments of the present invention, and those skilled in the art may readily make different substitutions and modifications. For example, the material of the ground plane 120, the radiators 142-144D, or the director 160 may include, for example, aluminum, copper, brass, other metals, other conductive material, alloys or mixture thereof, but is not limited thereto. In some embodiments, the antenna 10 or 50 may be a patch antenna. In some embodiments, the antenna 10 or 50 may be visualized as a resonant cavity formed by the radiator (s) and the ground plane 120, and fringing electric fields may form at edges of the radiator(s).

The relative position between the feed-in points may be adjusted in the present invention. Take the antenna 10 shown in FIG. 1 as an example. The feed-in points 142Ap and 142Bp are located at the top and on the left of the antenna 10 within the radiator 142; the feed-in points 144Ap and 144Bp are located at the bottom and on the right of the antenna 10 within the radiators 144A and 144B, respectively. The feed-in points 142Ap and 142Bp are arranged to be spaced apart (for instance, as far as possible) from the feed-in points 144Ap and 144Bp to improve isolation. However, the present invention is not limited thereto. The feed-in points 142Ap and 142Bp may be located at the bottom and on the right of the antenna 10 within the radiator 142, and thus adjacent to the feed-in points 144Ap and 144Bp.

The antenna of the present invention may switch between a linearly polarized radiation pattern and a circular polarized radiation pattern. Take the antenna 10 shown in FIG. 1 as an example. If the feed-in points 142Ap and 142Bp are fed at 90 degrees relative phase at a time, it may result in circular polarization (for instance, left hand or right hand circular polarization). If only one of the feed-in points 142Ap and 142Bp is fed, or if the feed-in points 142Ap and 142Bp are fed without phase difference, it may result in linear polarization (for instance, vertical or horizontal polarization).

The exact position of the feed-in points in the present invention may be adjusted according to different design consideration. Take the antenna 10 shown in FIG. 1 as an example. The feed-in point 142Ap or 144Ap may be moved to an axis XS1 (for instance, a symmetric axis of the radiators 142-144D) or approach the axis XS1; the feed-in points 142Bp and 144Bp may be moved to an axis XS2 (for instance, another symmetric axis of the radiators 142-144D) or approach the axis XS2. The feed-in points 142Ap and 142Bp may be disposed close to an edge DG of the radiator 142, adjacent to the edge DG, far from the edge DG, or near a center CNT of the radiator 142, but is not limited thereto. Similarly, the feed-in point 144Ap or 144Bp may be disposed adjacent to an edge or near a center of the radiator 144A or 144B, but is not limited thereto. The feed-in points 142Ap and 142Bp within the radiator 142 and the center CNT of the radiator 142 do not lie on one single line and thus are non-collinear. The feed-in points 142Ap and 142Bp (or the feed-in points 1442Ap and 144Bp) and the center CNT may define vertices of an imaginary right-angled triangle or an imaginary irregular triangle.

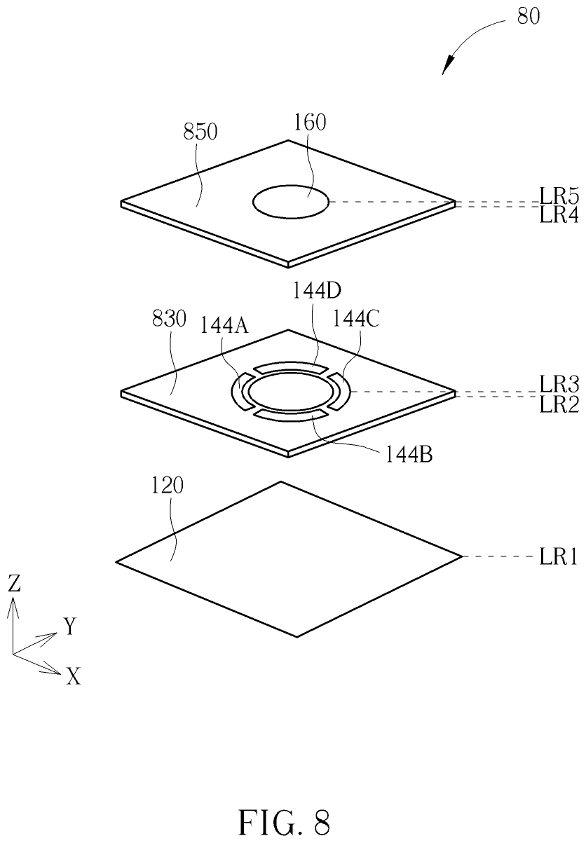

In addition, please refer to FIG. 8, which is a schematic diagram of an antenna 80 according to an embodiment of the present invention. The structure of the antenna 80 shown in FIG. 8 is similar to that of the antenna 10 shown in FIG. 1, and hence the same numerals and notations denote the same components in the following description. The antenna 80 may further include substrates 830 and 850. The material of the substrate 830 or 850 may include dielectric material to support and electrically isolate/insulate the radiators 142-144D from the ground plane 120 or the director 160.

As shown in FIG. 8, the ground plane 120 is disposed at a layer LR1. The substrate 830 is disposed at a layer LR2. The radiators 142, 144A, 144B, 144C, 144D are all located at a layer LR3, and hence are disposed between the ground plane 120 and the director 160. The substrate 850 is disposed at a layer LR4. The director 160 is disposed at a layer LR5. That is to say, the radiators 142 and 144A-144D are disposed in one plane parallel to the plane in which the ground plane 120 or the director 160 is disposed. In some embodiments, the radiators 142-144D are coplanar.

The geometric size of the antenna may be appropriately adjusted in the present invention. Take the antenna 10 shown in FIG. 1 as an example. The radiator 142 is spaced apart from the ground plane 120 by a distance H1 (by air) and is separated from the director 160 by a distance H2 (by air). In some embodiments, the distance H1 may be substantially 0.3 times as large as a first wavelength corresponding to the first frequency band of the antenna 10, and the distance H2 may be substantially 0.35 times as large as the first wavelength corresponding to the first frequency band of the antenna 10. In some embodiments, the distance H1 may be substantially 0.25 to 0.3 times as large as a first wavelength corresponding to the first frequency band of the antenna 10, and the distance H2 may be substantially 0.3 to 0.35 times as large as the first wavelength corresponding to the first frequency band of the antenna 10. In some embodiments, a width W1 of the director 160 may be substantially 0.15 times as large as the first wavelength corresponding to the first frequency band (in vacuum) plus a second wavelength corresponding to the second frequency band (in vacuum). In some embodiments, the width W1 of the director 160 may be substantially 0.1 to 0.15 times as large as the first wavelength corresponding to the first frequency band (in vacuum) plus a second wavelength corresponding to the second frequency band (in vacuum).

In FIG. 1, the radiators 142 and 144A-144D may be separated by air. In some embodiments, a diameter D1 of the radiators 142 may be substantially 0.5 times as large as the second wavelength corresponding to the second frequency band. In some embodiments, the diameter D1 of the radiators 142 may be substantially 0.4 to 0.6 times as large as the second wavelength corresponding to the second frequency band. In some embodiments, the diameter D1 of the radiators 142 may be in a range of 0.5 millimeter to 1.5 millimeter. In some embodiments, a width W2 of one of the radiators 144A-144D may be substantially 0.08 times as large as the first wavelength corresponding to the first frequency band. In some embodiments, the width W2 of one of the radiators 144A-144D may be substantially 0.07 to 0.09 times as large as the first wavelength corresponding to the first frequency band. In some embodiments, a gap G1 between the radiators 142 and one of the radiators 144A-144D may be substantially 0.06 times as large as the first wavelength corresponding to the first frequency band. In some embodiments, the gap G1 between the radiators 142 and one of the radiators 144A-144D may be substantially 0.05 to 0.07 times as large as the first wavelength corresponding to the first frequency band. In some embodiments, a gap G2 between two adjacent one of the radiators 144A-144D may be substantially 0.08 times as large as the first wavelength corresponding to the first frequency band. In some embodiments, the gap G2 between two adjacent one of the radiators 144A-144D may be substantially 0.07 to 0.09 times as large as the first wavelength corresponding to the first frequency band.

The geometric size of the antenna may vary according to the dielectric constant of the substrate 830 or 850 added into the antenna 80 shown in FIG. 8. For example, the geometric size of the antenna may satisfy the equation of ε_{eff}=(εᵣ+1)/2+(εᵣ−1)×(1+12×H1/D1)/2.

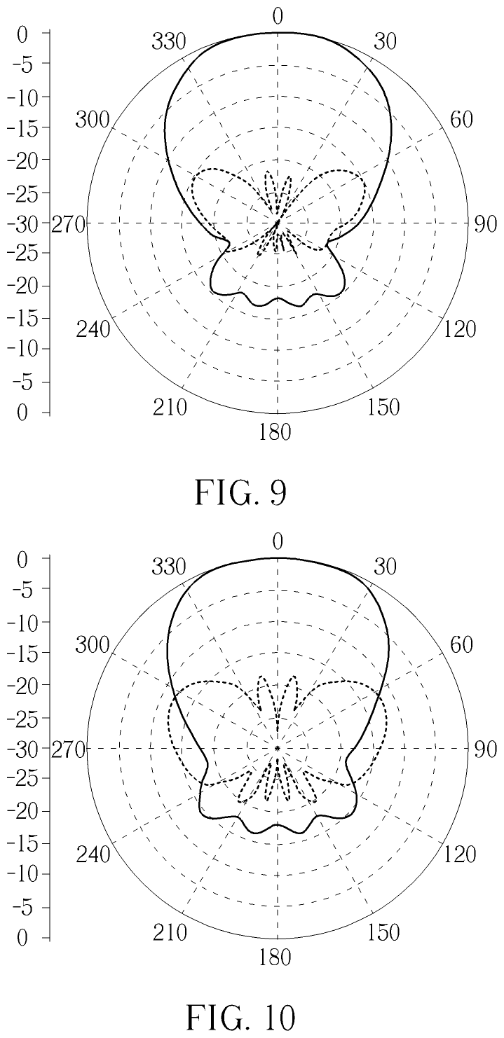

Please refer to FIG. 9 and FIG. 10. FIG. 9 is a schematic diagram of radiation field pattern for the first frequency band of the antenna 10 shown in FIG. 1. FIG. 10 is a schematic diagram of radiation field pattern for the second frequency band of the antenna 10 shown in FIG. 1. In FIG. 9 and FIG. 10, common polarization (co-pol) and cross polarization (x-pol) are presented by a solid curve and a dash curve respectively. According to FIG. 9 and FIG. 10, the antenna 10 has high gain values, desired orthogonal polarization isolation (or common polarization to cross polarization (Co/Cx) parameter), desired front-to-back (F/B) ratio and proper beamwidth.

In summary, the antenna of the present invention includes four second radiators surround a first radiator so as to operate in two frequency bands. The antenna of the present invention has two feed-in points located on different axes to ensure dual polarization capability. With the symmetry of the structure of the antenna of the present invention, polarizations may be changed without altering the arrangement of the first radiator and the second radiators. The antenna of the present invention further includes the director to provide broad band operation. In a word, the antenna of the present invention is a dual-polarized dual-band broadband antenna.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna structure, comprising:
a first radiator, in a shape corresponding to a circle, wherein the first radiator has a first feed-in point and a second feed-in point; and
a plurality of second radiators, each in a shape corresponding to an arc, wherein one of the plurality of second radiators has a third feed-in point, and another of the plurality of second radiators has a fourth feed-in point.

2. The antenna structure of claim 1, further comprising:
a ground plane; and
a director, concentric with the first radiator, wherein the first radiator and the plurality of second radiators are disposed between the ground plane and the director.

3. The antenna structure of claim 1, wherein the plurality of second radiators surrounding the first radiator are evenly distributed or symmetrically arranged.

4. The antenna structure of claim 1, wherein the first radiator and the plurality of second radiators are coplanar.

5. The antenna structure of claim 1, wherein
the first feed-in point or the third feed-in point is located on a first axis, and
the second feed-in point or the fourth feed-in point is located on a second axis different from the first axis.

6. The antenna structure of claim 1, wherein the antenna structure is switch between a first combination of vertically polarization and horizontally polarization and a second combination of +45 degrees slant polarization and −45 degrees slant polarization.

7. The antenna structure of claim 1, wherein
the first feed-in point or the third feed-in point is located on a first symmetric axis of the first radiator or a second symmetric axis of the first radiator, and
an angle between the first symmetric axis and the second symmetric axis is 45 degrees.

8. The antenna structure of claim 1, wherein a diameter of the first radiator is 0.4 to 0.6 times as large as a second wavelength corresponding to a second frequency band of the antenna structure.

9. The antenna structure of claim 1, wherein a first width of one of the plurality of second radiators is 0.07 to 0.09 times as large as a first wavelength corresponding to a first frequency band of the antenna structure.

10. The antenna structure of claim 1, wherein a first gap between the first radiator and one of the plurality of second radiators is 0.05 to 0.07 times as large as a first wavelength corresponding to a first frequency band of the antenna structure.

11. The antenna structure of claim 1, wherein a second gap between two adjacent one of the plurality of second radiators is 0.07 to 0.09 times as large as a first wavelength corresponding to a first frequency band of the antenna structure.

12. The antenna structure of claim 1, wherein a second width of the director is 0.1 to 0.15 times as large as a first wavelength corresponding to a first frequency band of the antenna structure plus a second wavelength corresponding to a second frequency band of the antenna structure.

13. The antenna structure of claim 1, wherein a first distance between the first radiator and the ground plane is 0.25 to 0.3 times as large as a first wavelength corresponding to a first frequency band of the antenna structure.

14. The antenna structure of claim 1, wherein a second distance between the first radiator and the director is 0.3 to 0.35 times as large as a first wavelength corresponding to a first frequency band of the antenna structure.

15. The antenna structure of claim 1, wherein the third feed-in point is located adjacent to an edge or near a center of one of the plurality of second radiators.
